(19) United States
(12) Patent Application Publication
(10) Pub. No.: US 2026/0087495 A1
(43) Pub. Date: Mar. 26, 2026

(54) PROGRAMMATICALLY CONTROLLING ACCESS TO RESOURCES IN AN ENVIRONMENT

(71) Applicant: Truist Bank, Charlotte, NC (US)

(72) Inventor: Matthew Laine Donlan, Charlotte, NC (US)

(73) Assignee: Truist Bank, Charlotte, NC (US)

(21) Appl. No.: 18/894,085

(22) Filed: Sep. 24, 2024

(51) Int. Cl. G06Q 20/40

(52) U.S. Cl. CPC G06Q 20/4016; G06Q 20/4014

(57) ABSTRACT

An application may receive a request associated with an entity. The application may determine a plurality of resources associated with the entity. The application may determine a plurality of scripts associated with the entity. The application may initiate performance of the plurality of scripts to disable access to the plurality of resources. The application may receive an indication that a first script of the plurality of scripts has disabled access to a first resource of the plurality of resources.

### BACKGROUND

Certain events may require corrective actions. For example, certain events may require that computing systems and/or computing resources be shut down or otherwise disabled such that they cannot be accessed. However, doing so requires a holistic view of all systems and/or resources managed or otherwise accessible to an entity. Furthermore, disabling disparate systems and/or resources often require different operations. As such, conventional solutions are largely manual, inefficient, and expose the associated entities with legal, compliance, and/or security risks.

### BRIEF SUMMARY

Embodiments of the present disclosure address the above needs and/or achieve other advantages by providing apparatuses and methods that securely disable access to resources.

In various embodiments, a method can be employed by a management application executing on a device's processor. This method involves the management application receiving a request associated with an entity and determining the resources linked to that entity. The management application may also determine scripts related to those resources. Subsequently, the application initiates these scripts to disable access to the corresponding resources and receives indications when the scripts have disabled access to the resources.

In certain embodiments, a non-transitory computer-readable storage medium contains instructions that enable the processor to execute this method upon execution. These instructions involve receiving a request associated with an entity, identifying the related resources, determining scripts for each resource, initiating these scripts to restrict access to the resources, and storing indications within a log reflecting the initiation of the first script's actions on the initial resource.

An apparatus comprising a processor is also part of the disclosure. When executed by the processor, it follows the same method steps: receiving an entity-associated request, identifying related resources, determining scripts for each resource, initiating these scripts to limit access, and recording indications that confirm the initiation of the first script's actions on the initial resource in a log.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates a system 100 in accordance with one embodiment.

FIG. 2 illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

FIG. 4 illustrates an aspect of the subject matter in accordance with one embodiment.

FIG. 5 illustrates a logic flow 500 in accordance with one embodiment.

FIG. 6 illustrates a logic flow 600 in accordance with one embodiment.

FIG. 7 illustrates a computing system 700 in accordance with one embodiment.

### DETAILED DESCRIPTION

Embodiments disclosed herein provide solutions to programmatically control access to various resources in an enterprise system. An enterprise system may be associated with an entity, such as a corporation, financial institution, educational institution, government entity, and the like. A given enterprise system may have a plurality of resources, such as hardware, software, and/or a combination thereof. Therefore, embodiments disclosed herein may programmatically enable and/or disable access to various resources in the enterprise system.

For example, a financial institution may provide various software features for moving funds, e.g., to process payments, transfer money between users, etc. However, when certain events occur, such as failure of the financial institution, these features must be disabled to comply with regulations. Conventionally, restricting access to these features was a manual process that required significant time and resources. For example, an administrator may have disabled a payment application while not disabling access to a database used by the payment application. As such, users may be able to transfer funds by accessing the database with other applications. Doing so places the financial institution in various business and/or legal risks.

Advantageously, embodiments disclosed herein maintain a holistic view of all resources associated with an entity and allow these resources (and/or a subset thereof) to be disabled with a single request. For example, embodiments disclosed herein may include various configurations that define a subset of the resources in the entity's enterprise and various attributes thereof. For example, resources may be associated with a priority level and one or more scripts to disable, shut down, or otherwise restrict access to the resource. When a request to disable the resources is received, embodiments disclosed herein may identify the associated resources and initiate performance of the associated scripts to disable access to the resources. For example, by identifying all resources that are associated with the transfer of money (e.g., applications, services, servers, databases, accounts, data centers, etc.), embodiments disclosed herein may securely disable the ability to move money in or out of the financial institution. Doing so improves the security and functioning of computing systems (including any data and/or associated resources) by ensuring proper access controls are maintained. Furthermore, by maintaining a log reflecting the moment in time a given resource is disabled, compliance with regulations may be proved. Further still, based on the foregoing advantages, embodiments disclosed herein advantageously manage access controls for all types of resources, regardless of manufacturer, version, implementation, interfaces, programming languages, etc. Doing so improves the functioning of systems that manage access controls. Embodiments are not limited in these contexts.

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the disclosure and enable one of ordinary skill in the art to make, use, and practice the disclosure.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

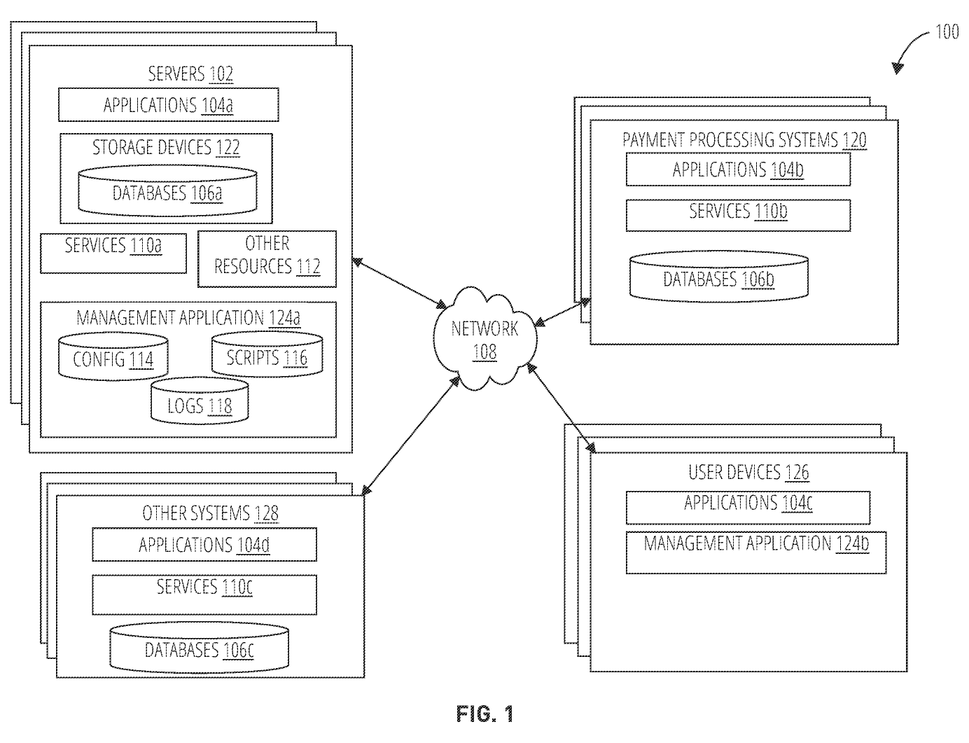

FIG. 1 illustrates a system 100 that controls access to resources, according to one embodiment. As shown, the system 100 includes one or more servers 102, one or more payment processing systems 120, one or more user devices 126, and one or more other systems 128 communicably coupled via one or more networks 108. The servers 102, payment processing systems 120, user devices 126, and/or other systems 128 are representative of any type of physical or virtualized computing system. The servers 102 may store or otherwise host a plurality of applications 104a, services 110a, and/or other resources 112. Similarly, the servers 102 may include storage devices 122 that store data such as databases 106a.

The payment processing systems 120 may store or otherwise host a plurality of applications 104b, services 110b, and databases 106b. The user devices 126 may store or otherwise execute a plurality of applications 104c. The other systems 128 may store or otherwise host a plurality of applications 104d, services 110c, and databases 106c.

The applications 104a-104d are representative of any number and type of application. For example, the applications 104a-104d may include web browsers, email clients, word processing applications, account management applications, mobile P2P payment system client applications, applications provided by financial institutions, financial applications, payment applications, monetary transfer applications, mobile wallet applications, accounting applications, payment processing frameworks, etc. The databases 106a-106c are representative of any number and type of databases, such as account databases for customer accounts, databases for payment accounts, production databases for applications, financial institution databases, databases for cached data, and databases for files such as those for user accounts, user profiles, account balances, and transaction histories, files downloaded or received from other devices, and other data items and the like. The services 110a-110c are representative of any number and type of services. For example, the services 110a-110c may include application programming interfaces (APIs), microservices, etc., that expose features and/or interface with the applications 104a-104d. For example, the services 110a-110c may include payment services, money transfer services, and the like. Furthermore, data itself may be considered a resource of the system 100, such as customer accounts, the funds in the customer accounts, the information in the customer accounts, etc. Example accounts include a checking account, a savings account, a money market account, a certificate of deposit, a mortgage or other loan account, a retirement account, a brokerage account, or any other type of account.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

As shown, the servers 102 include a respective instance of a management application 124a, while the user devices 126 include a respective instance of a management application 124b. The management application 124b may be the same as or similar to management application 124a. Generally, the management applications 124a, 124b facilitate access controls to any resource or entity in the system 100, as well as any resources and/or entities external to the system. For example, given a request to terminate the ability to perform monetary transfers, the management application 124a and/or management application 124b may identify all hardware and/or software components that can be used to transfer money and disable access to these components.

In some embodiments, the servers 102, user devices 126, and/or other systems 128 may be associated with an entity. Similarly, a subset of the payment processing systems 120 may be associated with the entity (e.g., one or more of the servers 102 associated with the entity may be payment processing systems 120), while other subsets of the payment processing systems 120 are associated with third parties. Similarly, the other systems 128 may be associated with the entity and/or third parties.

For example, a financial institution may maintain or otherwise be associated with the servers 102 and/or user devices 126. Similarly, some of the other systems 128 may be associated with the financial institution. As stated, one or more servers 102 and/or other systems 128 may be payment processing systems 120 that are part of a payment processing network (not pictured). However, some of the payment processing systems 120 and/or other systems 128 are associated with third parties, e.g., not managed or otherwise associated with the financial institution. Therefore, the network 108 may be representative of a private enterprise network, while the entities in the enterprise network connect to external entities (e.g., one or more of the payment processing systems 120 and/or the other systems 128) via a public network (e.g., the Internet).

As shown, the management application 124a includes a configuration data store 114, a data store of scripts 116, and a data store of logs 118. The management application 124b may include the configuration 114, scripts 116, and/or logs 118 (not pictured for clarity). The configuration 114 generally includes configuration information describing a plurality of entities in the system 100 (e.g., the servers 102 and components thereof, payment processing systems 120 and components thereof, user devices 126 and components thereof, and/or the other systems 128 and components thereof). In some embodiments, the configuration 114 includes a unique identifier of a resource (and/or a type of resource), a priority level, an associated script in the scripts 116, one or more dependencies, and a status of the resource. In some embodiments, the configuration 114 may further include a metadata description of the resource, which may facilitate identifying the resource. For example, an Automated Clearing House (ACH) payment processing application in the applications 104a-104d may be associated with a priority level, one or more scripts in the scripts 116, one or more services 110a-110c, one or more of the payment processing systems 120, one or more data centers providing resources, one or more portions of the network 108, and a metadata description that the application is associated with ACH payments. Embodiments are not limited in these contexts.

As another example, an entry in the configuration 114 to restrict the bi-directional transfer of funds by a financial institution may include an associated priority level, one or more scripts 116 associated with restricting the bi-directional transfer of funds by the financial institution, one or more applications 104a-104d associated with money transfers, one or more services 110a-110c associated with money transfers, one or more payment processing systems 120 associated with the financial institution that performs and/or facilitates money transfers, one or more third party payment processing systems 120 and/or services 110a-110c that performs and/or facilitates money transfers, one or more other systems 128 that performs and/or facilitates money transfers. By identifying all possible resources which can be used to transfer funds, and executing scripts 116 to disable these resources (or otherwise restricting access to these resources), the ability to transfer funds by an institution can be securely restricted.

The scripts 116 include computer-readable instructions that are executable to disable, shut down, or otherwise control access to one or more resources. For example, a script in the scripts 116 may sever a network 108 and/or a portion thereof, shut down one or more of the databases 106a-106c, shut down one or more of the servers 102, shut down specific processes within one or more of the applications 104a-104d (e.g., disable a payment process, processes supporting the payment process, etc.). Therefore, using a set of instructions in the scripts 116, software, machines, networks, and/or components thereof can be shut down or otherwise disabled programmatically in an automated fashion. Conversely, the instructions in the scripts 116 may further include instructions to start up, enable, or otherwise grant access to resources in the system 100.

The network 108 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The payment processing systems 120 include automatic teller machines (ATMs) utilized by the enterprise system 100 in serving users. In another example, the payment processing systems 120 represent payment clearinghouse or payment rail systems for processing payment transactions, and in another example, the external systems payment processing systems 120 represent third-party systems such as merchant systems or banking systems configured to interact with the user devices 126 during transactions and also configured to interact with the enterprise system 100 (e.g., the servers 102 and/or other payment processing systems 120) in back-end transactions clearing processes.

In some embodiments, a user may create or otherwise a request to disable access to a given entity in the system 100 via the management applications 124a, 124b. For example, the management applications 124a, 124b may include a selectable graphical user interface (GUI) element such as a button, link, etc., that allows a user to initiate the enabling and/or disabling of a given entity or set of entities. For example, a selectable GUI element may allow the user to instruct the management application 124a, 124b to restrict access to monetary transfers by a financial institution. Similarly, a selectable GUI element may allow the user to instruct the management application 124a, 124b to enable access to monetary transfers within a financial institution. As another example, a selectable GUI element may allow the user to instruct the management application 124a, 124b to restrict access to other entities, such as one or more of the servers 102, applications 104a-104d, user devices 126, other systems 128, payment processing systems 120, network 108, services 110a-110c, databases 106a-106c, and the like. As another example, a selectable GUI element may allow the user to instruct the management application 124a, 124b to restrict access to other entities, such as one or more types of resources (e.g., external monetary transfers, internal monetary transfers, APIs, services, applications, hardware, etc.).

In some embodiments, the management application 124a, 124b may detect a triggering event to initiate access controls. For example, if a ratio of debt to assets is above a threshold, the management application 124a, 124b may trigger one or more scripts 116 to restrict bi-directional monetary transfers by the financial institution. As another example, the management application 124a, 124b may determine that the financial institution has assets that are below a threshold, and trigger one or more scripts 116 to restrict bi-directional monetary transfers by the financial institution. As another example, the financial institution may receive a notice (e.g., email, fax, letter, etc.) from regulatory authorities indicating the financial institution must cease monetary transfers. In response, the management application 124a, 124b may trigger one or more scripts 116 to restrict bi-directional monetary transfers by the financial institution.

In some embodiments, the management application 124a, 124b may order the execution of one or more scripts 116 based on priority levels of the associated resource in the configuration 114. For example, the management application 124a, 124b may first initiate the execution of scripts 116 associated with higher-priority resources, followed by scripts 116 associated with lower-priority resources.

In some embodiments, a given script in the scripts 116 may not result in the desired effect, e.g., shutting down one of the servers 102, disabling a feature of one of the applications 104a-104d, etc. In such embodiments, the management application 124a, 124b may identify one or more other scripts in the scripts 116 that are similar to the executed script that did not result in the desired effect. For example, using a clustering algorithm executed based on the instructions in the scripts 116, the management application 124a, 124b may identify other scripts 116 and execute one or more of the identified scripts 116, e.g., to shut down the servers 102, disable a feature of one of the applications 104a-104d, etc.

The logs 118 include entries indicating when access to a given resource is enabled and/or disabled. For example, as the scripts 116 execute, the scripts 116 may inform the management application 124a, 124b that access to a given resource has been restricted. As such, the management application 124a, 124b may create an entry in the logs 118 indicating that access to the resource has been restricted (and/or that the resource has been shut down or otherwise disabled). The entries in the logs 118 may include indications of the resource, an associated operation (e.g., shutting down a resource, restricting access to a resource, etc.), and an associated timestamp. Doing so may help the entity prove compliance via the logs 118.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 126) to serve users in their interactions to communicate and take action. In such embodiments, the user devices 126 can be, as non-limiting examples, computing devices, kiosks, terminals, smart devices such as phones, and devices and tools at customer service counters and windows at POS locations.

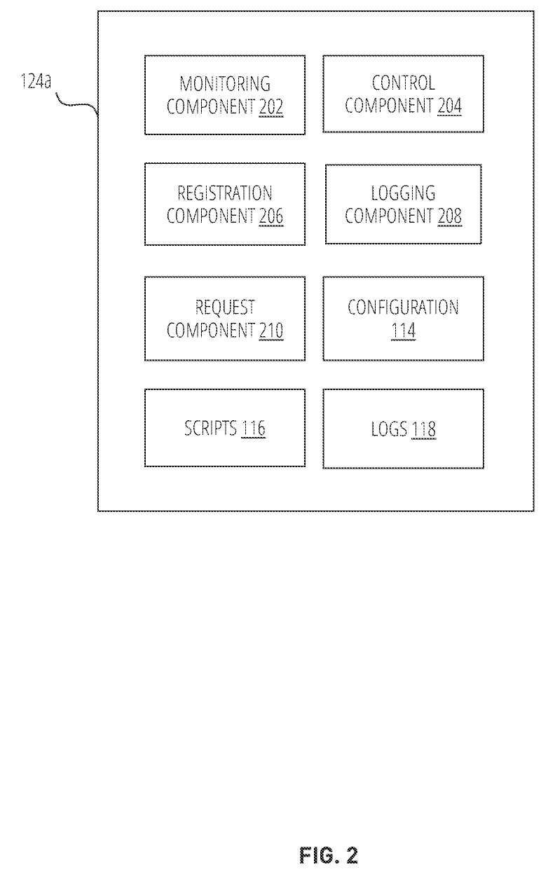

FIG. 2 is a schematic illustrating components of the management application 124a, according to one embodiment. The use of the management application 124a as an example in FIG. 2 should not be considered limiting of the disclosure, as the components depicted in FIG. 2 may be included in the management application 124b.

As shown, the management application 124a includes a monitoring component 202, a control component 204, a registration component 206, a logging component 208, and a request component 210. The monitoring component 202 may be configured to monitor the state of resources in the system 100, monitor the state of executing scripts 116, or monitor any other attribute of the system 100. For example, the monitoring component 202 may monitor the amount of computing resources used by the applications 104a-104d, services 110a-110c, databases 106a-106c, etc. Similarly, the monitoring component 202 may monitor the used amount of computing resources of the servers 102, payment processing systems 120, other systems 128, and/or user devices 126. As another example, the monitoring component 202 may monitor the number of operations per second of software and/or hardware, the amount of funds transferred using hardware and/or software, etc. When monitoring the scripts 116, the monitoring component 202 may receive information from the scripts 116 indicating the status of various operations. When the scripts 116 report completion of an operation, a logging component 208 of the management application 124a may store one or more entries in the logs 118 reflecting the completed operations. In some embodiments, the monitoring component 202 may transmit notifications as operations are completed and/or failed. For example, the monitoring component 202 may transmit a push notification to a requesting user device 126 indicating the databases 106a associated with processing payments have been disabled. As another example, the monitoring component 202 may transmit an email indicating access to applications 104a-104d and/or services 110a-110c associated ACH payments, wire-based payments, real-time payments, Zelle payments, FedNow payments, and payments using funds associated with the financial institution initiated via a third party payment processing system 120 have been disabled. Recipients of notifications may include predetermined recipients, recipients providing their information when submitting a request, and/or recipients associated with one or more resource(s) being managed.

The request component 210 is configured to receive user requests to control access to resources in the system 100. For example, the user may specify a resource, a resource type, etc., and an associated operation (e.g., restrict all monetary transfers by a financial institution, restrict access to all databases 106a-106c, shut down one or more servers 102, etc.). The control component 204 is generally configured to identify one or more resources to be controlled responsive to a request received by the request component 210. For example, the control component 204 may identify one or more entries in the configuration 114 based on the request. For example, if the request is to restrict monetary transfers, the control component 204 may identify all hardware and/or software associated with monetary transfers in the configuration 114. The control component 204 may then initiate one or more scripts 116 associated with the identified entries in the configuration 114 to implement the requested access controls.

The registration component 206 is configured to manage entries in the configuration 114 and/or scripts 116. For example, via the registration component 206, users may add new entries to the configuration 114 and/or scripts 116, remove entries from the configuration 114 and/or scripts 116, and/or modify entries in the configuration 114 and/or scripts 116. In some embodiments, the monitoring component 202 may determine one or more resources that should have been disabled were not disabled by the scripts 116 executed by the control component 204. In such embodiments, the user may provide updated instructions to the registration component 206, e.g., a new, different, and/or modified script to be included in the scripts 116. The control component 204 may receive an indication of the selected script in the scripts 116, and initiate execution of the selected script to disable access to the associated resource.

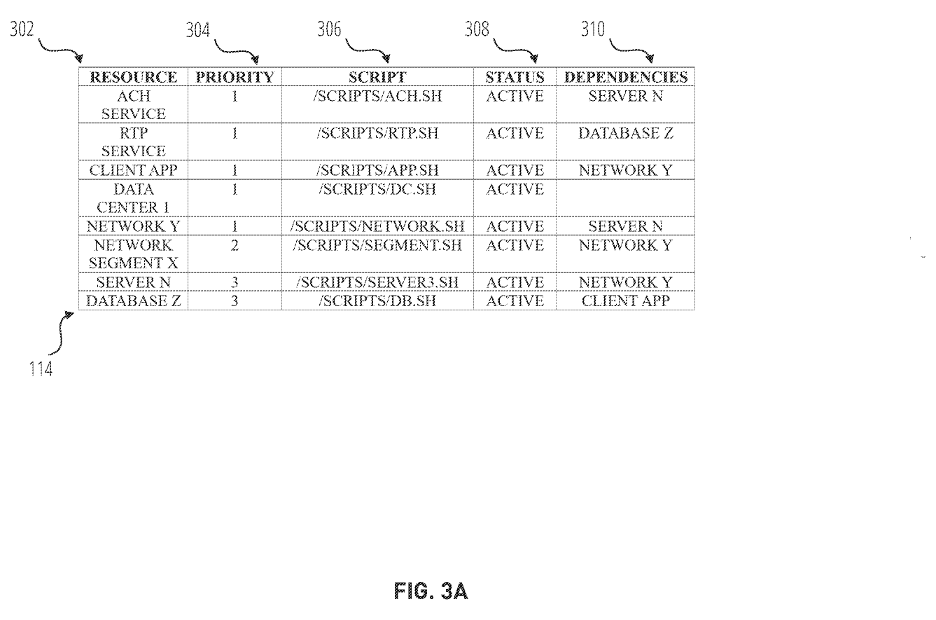

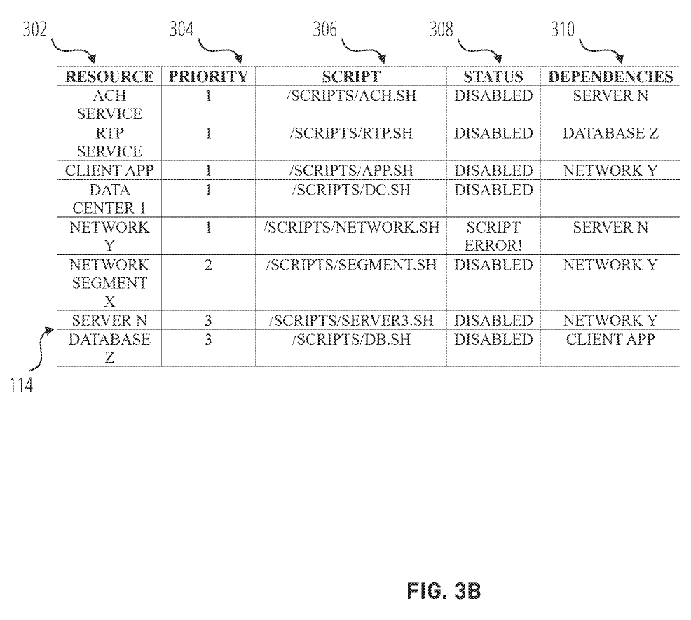

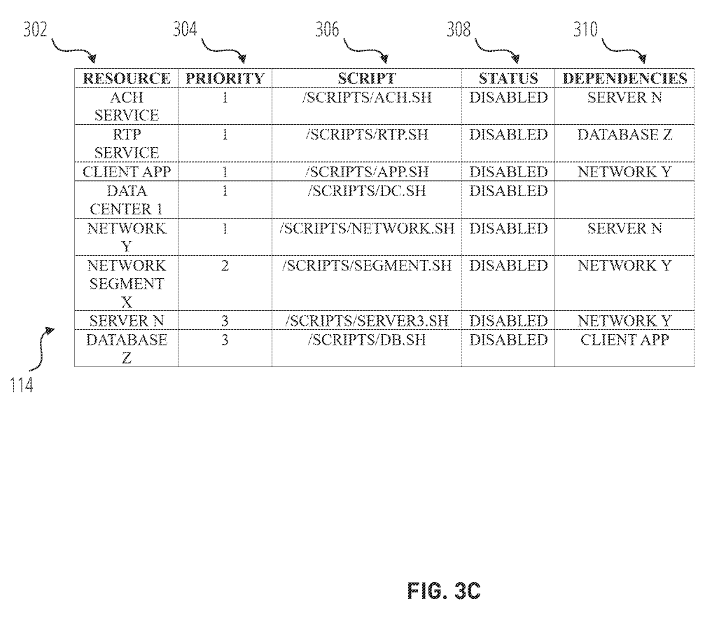

FIG. 3A illustrates an example set of entries in the configuration 114, according to one embodiment. As stated, the configuration 114 generally includes a catalog of all resources in a system such as system 100. The set of entries depicted in FIG. 3A-FIG. 3C may correspond to a subset of entries in the configuration 114 that are associated with a requested operation (e.g., to restrict monetary transfers by a financial institution). As shown, the configuration 114 includes a resource ID field 302, a priority field 304, a script field 306, a status field 308, and a dependencies field 310.

The resource ID field 302 may uniquely identify a resource, such as a hardware resource, a software resource, a network resource, or any combination thereof. For example, as shown, the resource ID field 302 includes entries for an ACH service, real-time payments (RTP) service, etc. As other examples, the resource ID field 302 may identify types of resources (e.g., servers, databases, funds, currencies, account information, etc.). The priority field 304 indicates a priority value for the resource, such that the management application 124a, 124b may optionally order the sequence of operations (e.g., executing the script for the client app prior to executing the script for server N). The script field 306 indicates one or more scripts 116 to control access to a given resource, e.g., to shut down a resource, take a resource offline, implement access controls for a resource (e.g., to grant or revoke access), etc. The status field 308 may indicate a status of the associated resource, e.g., active, disabled, etc. The dependencies field 310 may include the identifier of one or more other resources that are dependent on (and/or associated with) the current resource. For example, the entry for ACH service is associated with server N. Therefore, if not expressly included in the subset of items in the configuration 114 for a requested operation, the management application 124a may identify the server N association with ACH service, and ensure that the scripts 116 associated with server N are executed to properly disable and/or enable a resource.

Therefore, when processing a request, the management application 124a may initiate the execution of all scripts in the script field 306. Embodiments are not limited in these contexts.

FIG. 3B illustrates an embodiment where the management application 124a initiated the execution of scripts in the script field 306 depicted in FIG. 3A. As shown in FIG. 3B, the execution of the scripts 116 successfully disabled all resources except for the network Y. In response, the management application 124a may identify another script associated with restricting access to network Y and execute the script. As another example, the management application 124a may transmit a notification to a user reflecting the error. In such embodiments, the user may manually initiate one or more operations and/or scripts to disable the network Y. Embodiments are not limited in these contexts.

FIG. 3C illustrates an embodiment where the management application 124a successfully disabled all resources listed in FIG. 3A. As stated, the management application 124a may create entries in the logs 118 as each item in the configuration 114 is disabled. Similarly, the management application 124a may transmit notifications to requesting and/or registered users as each item (and/or all items) are disabled. Embodiments are not limited in these contexts.

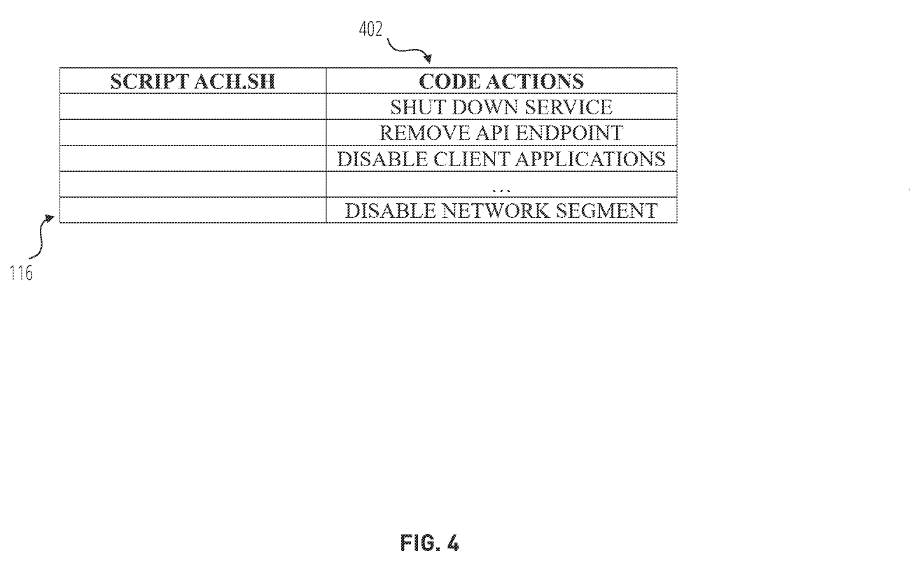

FIG. 4 illustrates an example set of actions 402 associated with a script in the scripts 116, according to one embodiment. Although the example actions 402 are depicted in English, the actions 402 generally reflect operations that can be implemented in computer-executable code in one of the scripts 116. For example, as shown, the actions 402 describe operations including shutting down a service, removing an API endpoint, disabling client applications, and disabling a network segment. Therefore, the script in the scripts 116 may include computer-executable code to shut down a service, remove an API endpoint, disable client applications, and disable a network segment. Embodiments are not limited in these contexts.

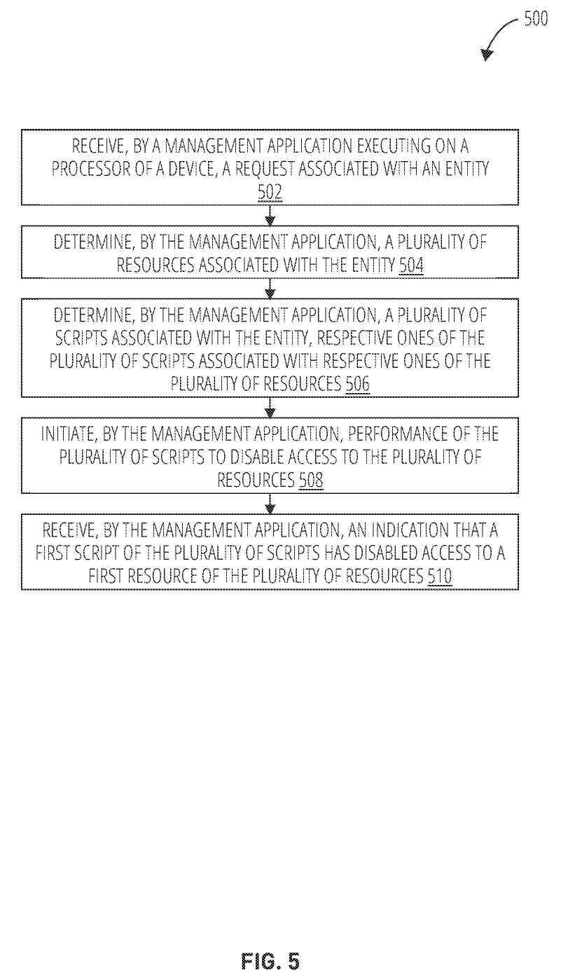

FIG. 5 illustrates a logic flow 500. Logic flow 500 is representative of some or all of the operations to programmatically control access to a resource. Although the example logic flow 500 depicts a particular sequence of operations, the sequence may be altered without departing from the scope of the present disclosure. For example, some of the operations depicted may be performed in parallel or in a different sequence that does not materially affect the function of the logic flow 500. In other examples, different components of an example device or system that implements the logic flow 500 may perform functions at substantially the same time or in a specific sequence.

In block 502, logic flow 500 receives, by a management application such as management application 124a or management application 124b, a request associated with an entity. The request may be generated based on a detected event and/or may be based on user input. For example, if a financial institution fails and must cease all monetary transfers, a user may generate the request using the management application 124a and/or management application 124b.

In block 504, logic flow 500 determines, by the management application, a plurality of resources associated with the entity. For example, the management application 124a may determine a set of resources associated with monetary transfers, e.g., based on the configuration 114. In block 506, logic flow 500 determines, by the management application, a plurality of scripts associated with the entity, respective ones of the plurality of scripts associated with respective ones of the plurality of resources. For example, the management application 124a may determine the scripts 116 for the resources identified at block 504 based on the configuration 114.

In block 508, logic flow 500 initiates, by the management application, performance of the plurality of scripts to disable access to the plurality of resources. For example, the execution of the scripts 116 may restrict the ability for anyone to transfer money in or out of a financial institution. In block 510, logic flow 500 receives, by the management application, an indication that a first script of the plurality of scripts has disabled access to a first resource of the plurality of resources. Doing so may allow the management application 124a to create and store an entry in the logs 118. Embodiments are not limited in these contexts.

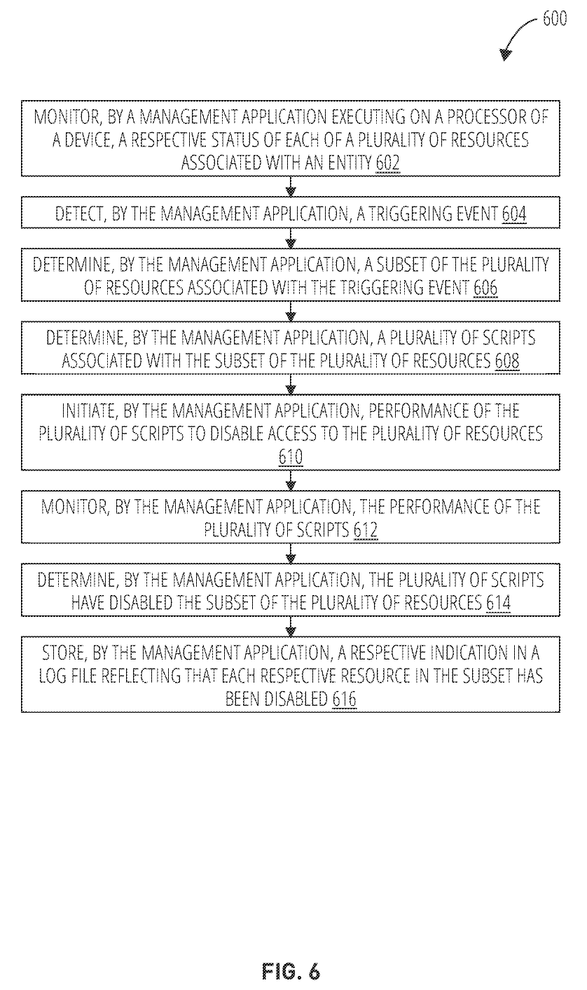

FIG. 6 illustrates an example logic flow 600 to programmatically control access to a resource. Although the example logic flow 600 depicts a particular sequence of operations, the sequence may be altered without departing from the scope of the present disclosure. For example, some of the operations depicted may be performed in parallel or in a different sequence that does not materially affect the function of the logic flow 600. In other examples, different components of an example device or system that implements the logic flow 600 may perform functions at substantially the same time or in a specific sequence.

According to some examples, the logic flow 600 includes monitoring, by a management application executing on a processor of a device, a respective status of each of a plurality of resources associated with an entity at block 602. For example, the management application 124a illustrated in FIG. 1 may monitor, a respective status of each of a plurality of resources associated with an entity, e.g., the resources of system 100.

According to some examples, the logic flow 600 includes detecting, by the management application, a triggering event at block 604. For example, the management application 124a may detect, by the management application, a triggering event. According to some examples, the logic flow 600 includes determining, by the management application, a subset of the plurality of resources associated with the triggering event at block 606. For example, the management application 124a may determine, by the management application, a subset of the plurality of resources associated with the triggering event based on the configuration 114.

According to some examples, the logic flow 600 includes determining, by the management application, a plurality of scripts associated with the subset of the plurality of resources at block 608. For example, the management application 124a may determine a plurality of scripts 116 associated with the subset of the plurality of resources based on the configuration 114.

According to some examples, the logic flow 600 includes initiating, by the management application, performance of the plurality of scripts to disable access to the plurality of resources at block 610. For example, the management application 124a may initiate performance of the plurality of scripts identified at 608 to disable access to the plurality of resources.

According to some examples, the logic flow 600 includes monitoring, by the management application, the performance of the plurality of scripts at block 612. For example, the management application 124a may monitor the performance of the plurality of scripts 116, e.g., to determine a status of the execution of the scripts 116. For example, the management application 124a may poll the scripts 116 or other components of the system 100 to identify a status (e.g., enabled, disabled, etc.). Similarly, the scripts 116 may be configured to return status information to the management application 124a or 124b.

According to some examples, the logic flow 600 includes determining, by the management application, the plurality of scripts have disabled the subset of the plurality of resources at block 614. For example, the management application 124a may determine the plurality of scripts have disabled the subset of the plurality of resources.

According to some examples, the method includes storing, by the management application, a respective indication in a log file reflecting that each respective resource in the subset has been disabled at block 616. For example, the management application 124a may store a respective indication in a log file in the logs 118 reflecting that each respective resource in the subset has been disabled. Embodiments are not limited in these contexts.

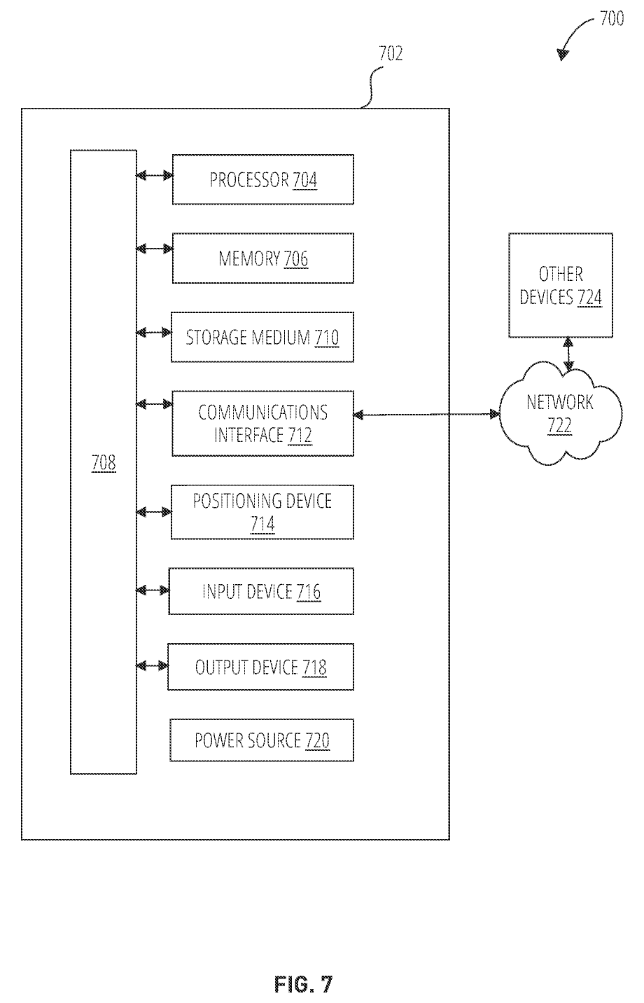

FIG. 7 illustrates an example computing system 700 suitable for implementing various embodiments as described herein. As shown, the computing system 700 comprises a computer 702, which is representative of any type of physical and/or virtualized computing device. Examples of the computer 702 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), or any other device with processing capabilities. In one embodiment, the computer 702 is representative of some or all of the components of the servers 102, payment processing systems 120, user devices 126, and/or network 108.

As shown, the computer 702 includes one or more processors 704, one or more memories 706, one or more non-transitory storage media 710, one or more communications interfaces 712, one or more positioning devices 714, one or more input devices 716, and one or more output devices 718 communicably coupled via an interconnect 708. A power source 720, such as a power supply, battery, or any type of power source may provide power to the computer 702.

The processor 704 is representative of any type of processing circuit. For example, the processor 704 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 706 is representative of any computer readable medium to store data, code, or other information. The memory 706 may include volatile memory, such as volatile Random Access Memory (RAM) including a cache area for the temporary storage of data. The memory 706 may also include non-volatile memory, which can be embedded and/or may be removable. The non-volatile memory can additionally or alternatively include an electrically erasable programmable read-only memory (EEPROM), flash memory or the like. The storage medium 710 is representative of any type of computer readable medium to store data, code, or other information. Examples of storage media 710 include solid state drives, hard drives, Redundant Array of Independent Disks (RAID) drives, memory pools, USB storage devices, and the like.

The memory 706 and storage medium 710 can store any number and type of computer-executable instructions executed by the processor 704 to implement the functions of the computer 702 described herein. For example, the memory 706 may include such applications as a web browser application and/or a mobile P2P payment system client application. These applications also typically provide a graphical user interface (GUI) on a display that allows the user to communicate with the computer 702, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 706 and/or storage medium 710 may be used to store data such as cached data, files for user accounts, user profiles, account balances, transaction histories, files downloaded or received from other devices, and any other data items.

The interconnect 708 is representative of any type of circuitry to connect the components of the computer 702. For example, the interconnect 708 can include or represent, a system bus, a universal serial bus (USB) interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 704 to the memory 706, individual electrical connections among the components, and electrical conductive traces on a motherboard common to some or all of the above-described components of the computer 702. As discussed herein, the interconnect 708 may operatively couple various components with one another, or in other words, electrically connects those components, either directly or indirectly—by way of intermediate component(s)—with one another.

The one or more input devices 716 are representative of any type of input device for receiving input, such as a keypad, keyboard, touch-screen, touchpad, microphone, camera, fingerprint sensor, mouse, joystick, other pointer device, button, soft key, and the like. The one or more output devices 718 are representative of any type of device for outputting information, such as a monitor, speaker, haptic feedback module, printer, and the like.

The computer 702 may use the communications interface 712 to communicate with one or more other devices 724 via a network 722. The communications interface 712 allows the computer 702 to communicate with and conduct transactions with other devices and systems, such as the other devices 724. The communications interface 712 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 712, which can be or include a radio-frequency transceiver, a Bluetooth device, Wi-Fi device, a Near-Field Communication (NFC) device, and other wireless transceivers. In addition, a positioning device 714 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 712, e.g., using USB, Ethernet, and other physically connected modes of data transfer. The network 722 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 702 is configured to use the communications interface 712 as, for example, a network interface to communicate with one or more other devices on a network such as network 722. In this regard, the computer 702 utilizes the wireless communications interface 712 as an antenna operatively coupled to a transmitter and a receiver (together a “transceiver”) included with the communications interface 712. The communications interface 712 is configured to provide signals to and receive signals from the transmitter and receiver, respectively. The signals may include signaling information in accordance with the air interface standard of the applicable cellular system of a wireless telephone network. In this regard, the computer 702 may be configured to operate with one or more air interface standards, communication protocols, modulation types, and access types. By way of illustration, the computer 702 may be configured to operate in accordance with any of a number of first, second, third, fourth, fifth-generation communication protocols and/or the like. For example, the as a smartphone, the computer 702 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 702 may also be configured to operate in accordance with non-cellular communication mechanisms, such as via a wireless local area network (WLAN) or other communication/data networks.

The communications interface 712 may also include a payment network interface. The payment network interface may include software, such as encryption software, and hardware, such as a modem, for communicating information to and/or from one or more devices on a network. For example, the computer 702 may be configured so that it can be used as a credit or debit card by, for example, wirelessly communicating account numbers or other authentication information to a terminal of the network. Such communication could be performed via transmission over a wireless communication protocol such as the NFC protocol.

The computer 702 may be under the control of any suitable operating system (not pictured). Example operating systems include, but are not limited to, Linux® operating systems, UNIX®, Windows® operating systems, macOS®, iOS®, Android® and any other type of operating system.

The computer 702 as illustrated diagrammatically represents at least one example of a possible implementation, where alternatives, additions, and modifications are possible for performing some or all of the described methods, operations and functions. Although shown separately, in some embodiments, two or more computers 702, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
receiving, by a management application executing on a processor of a device, a request associated with an entity;
determining, by the management application, a plurality of resources associated with the entity;
determining, by the management application, a plurality of scripts associated with the entity, respective ones of the plurality of scripts associated with respective ones of the plurality of resources;
initiating, by the management application, performance of the plurality of scripts to disable access to the plurality of resources; and
receiving, by the management application, an indication that a first script of the plurality of scripts has disabled access to a first resource of the plurality of resources.

2. The method of claim 1, wherein the plurality of resources comprise: (i) servers, (ii) applications, (iii) databases, (iv) data centers, (v) services, (vi) network segments, (vii) funds, and (viii) accounts.

3. The method of claim 1, further comprising:
determining, by the management application, that the plurality of scripts have disabled access to the plurality of resources; and
storing, by the management application, one or more indications in a log reflecting that the plurality of scripts have disabled access to the plurality of resources.

4. The method of claim 1, further comprising:
determining, by the management application, that access to a second resource of the plurality of resources has not been disabled via a second script of the plurality of scripts;
identifying, by the management application, one or more operations associated with the second resource in a third script of the plurality of scripts; and
initiating, by the management application, performance of the one or more operations associated with the second resource in the third script.

5. The method of claim 4, further comprising:
determining, by the management application, that access to the second resource has not been disabled via the performance of the one or more operations associated with the second resource in the third script;
determining, by the management application, a recipient associated with the second resource; and
transmitting, by the management application to the recipient, an indication that access to the second resource has not been disabled.

6. The method of claim 1, further comprising, prior to initiating performance of the plurality of scripts:
determining, by the management application, a respective priority value for each of the plurality of resources; and
initiating, by the management application, the performance of the plurality of scripts based on the priority values of the plurality of resources.

7. The method of claim 1, further comprising:
determining, by the management application, an external resource associated with the first resource;
determining, by the management application, a network segment connecting the first resource to the external resource; and
disabling, by the management application, the network segment connecting the first resource to the external resource.

8. A non-transitory computer-readable storage medium, the computer-readable storage medium including instructions that when executed by a processor, cause the processor to:
receive, by a management application, a request associated with an entity;
determine, by the management application, a plurality of resources associated with the entity;
determine, by the management application, a plurality of scripts associated with the entity, respective ones of the plurality of scripts associated with respective ones of the plurality of resources;
initiate, by the management application, performance of the plurality of scripts to disable access to the plurality of resources; and
store, by the management application, an indication in a log reflecting that a first script of the plurality of scripts has been initiated to disable access to a first resource of the plurality of resources.

9. The computer-readable storage medium of claim 8, wherein the plurality of resources comprise: (i) servers, (ii) applications, (iii) databases, (iv) data centers, (v) services, (vi) network segments, (vii) funds, and (viii) accounts.

10. The computer-readable storage medium of claim 8, wherein the instructions further cause the processor to:
receive, by the management application, indications that the plurality of scripts have disabled access to the plurality of resources; and
store, by the management application based on the received indications, one or more indications in the log reflecting that the plurality of scripts have disabled access to the plurality of resources.

11. The computer-readable storage medium of claim 8, wherein the instructions further cause the processor to:
determine, by the management application, that access to a second resource of the plurality of resources has not been disabled via a second script of the plurality of scripts;
identify, by the management application, one or more operations associated with the second resource in a third script of the plurality of scripts; and
initiate, by the management application, performance of the one or more operations associated with the second resource in the third script.

12. The computer-readable storage medium of claim 11, wherein the instructions further cause the processor to:
determine, by the management application, that access to the second resource has not been disabled via the performance of the one or more operations associated with the second resource in the third script;
determine, by the management application, a recipient associated with the second resource; and
transmit, by the management application to the recipient, an indication that access to the second resource has not been disabled.

13. The computer-readable storage medium of claim 8, wherein the instructions further cause the processor to, prior to initiating performance of the plurality of scripts:
determine, by the management application, a respective priority value for each of the plurality of resources; and
initiate, by the management application, the performance of the plurality of scripts based on the priority values of the plurality of resources.

14. The computer-readable storage medium of claim 8, wherein the instructions further cause the processor to:
determine, by the management application, an external resource associated with the first resource;
determine, by the management application, a network segment connecting the first resource to the external resource; and
disable, by the management application, the network segment connecting the first resource to the external resource.

15. An apparatus, comprising:
a processor; and
a memory storing instructions that, when executed by the processor, cause the processor to:
receive, by a management application, a request associated with an entity;
determine, by the management application, a plurality of resources associated with the entity;
determine, by the management application, a plurality of scripts associated with the entity, respective ones of the plurality of scripts associated with respective ones of the plurality of resources;
initiate, by the management application, performance of the plurality of scripts to disable access to the plurality of resources; and
receive, by the management application, an indication that a first script of the plurality of scripts has disabled access to a first resource of the plurality of resources.

16. The apparatus of claim 15, wherein the plurality of resources comprise: (i) servers, (ii) applications, (iii) databases, (iv) data centers, (v) services, (vi) network segments, (vii) funds, and (viii) accounts.

17. The apparatus of claim 15, wherein the instructions further cause the processor to:
determine, by the management application, that the plurality of scripts have disabled access to the plurality of resources; and
store, by the management application, one or more indications in a log reflecting that the plurality of scripts have disabled access to the plurality of resources.

18. The apparatus of claim 15, wherein the instructions further cause the processor to:
determine, by the management application, that access to a second resource of the plurality of resources has not been disabled via a second script of the plurality of scripts;
identify, by the management application, one or more operations associated with the second resource in a third script of the plurality of scripts; and
initiate, by the management application, performance of the one or more operations associated with the second resource in the third script.

19. The apparatus of claim 18, wherein the instructions further cause the processor to:
determine, by the management application, that access to the second resource has not been disabled via the performance of the one or more operations associated with the second resource in the third script;
determine, by the management application, a recipient associated with the second resource; and
transmit, by the management application to the recipient, an indication that access to the second resource has not been disabled.

20. The apparatus of claim 15, wherein the instructions further cause the processor to, prior to initiating performance of the plurality of scripts:
determine, by the management application, a respective priority value for each of the plurality of resources; and
initiate, by the management application, the performance of the plurality of scripts based on the priority values of the plurality of resources.
